(19) United States
(12) Patent Application Publication
(10) Pub. No.: US 2010/0242036 A1
(43) Pub. Date: Sep. 23, 2010

(54) INFORMATION PROCESSING APPARATUS, MODIFICATION MONITORING METHOD AND PROGRAM

(76) Inventor: Yasunori Aramaki, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/652,420

(22) Filed: Jan. 5, 2010

(30) Foreign Application Priority Data
Mar. 18, 2009 (JP) 2009-066641

(51) Int. Cl. G06F 9/445; G06F 3/048

(52) U.S. Cl. 717/174; 715/764

(57) ABSTRACT

According to one embodiment, an information processing apparatus includes a storage device wherein an operating system is installed, a detecting module configured to detect a process of installing a program to be operated on the operating system into the storage device and a performance of the information processing apparatus, and a display unit configured to store information indicating the performance of the information processing apparatus and information indicating install program which are detected by the detecting module into the storage device and to display the stored each of the information indicating the performance of the information processing apparatus and the information indicating install program in associate with temporal sequence in a graphic form.

### CROSS-REFERENCE TO RELATED APPLICATIONS

This application is based upon and claims the benefit of priority from Japanese Patent Application No. 2009-066641, filed Mar. 18, 2009, the entire contents of which are incorporated herein by reference.

### BACKGROUND

1. Field

One embodiment of the present invention relates to an information processing apparatus that monitors an installed program and more particularly to an information processing apparatus, modification monitoring method and program capable of time-sequentially acquiring a modification by comparing a modification in the performance of the information processing apparatus with the installed program.

2. Description of the Related Art

Generally, in a personal computer or the like, there is a tendency to install various drivers or install application programs as the device is used. Thus, the performance of the personal computer may be lowered by installing various drivers and application programs. Further, the performance of the personal computer may be lowered by aging degradation of the various components of the personal computer. For example, in Jpn. Pat. Appln. KOKAI Publication No. 2007-219977, there is disclosed a technique for reducing the boot time of the personal computer by changing the order of the sequence of the booting process of the personal computer if the performance of the personal computer is lowered, for example, if the boot time thereof becomes longer due to aging degradation of various components of the personal computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus according to one embodiment of this invention.

FIG. 2 is an exemplary block diagram schematically showing the configuration of the information processing apparatus according to one embodiment of this invention.

FIG. 3 is an exemplary block diagram showing the functional configuration of a modification monitoring application program used in the information processing apparatus according to one embodiment of this invention.

FIG. 4 is an exemplary flowchart for illustrating a modification monitoring method to which the information processing apparatus according to one embodiment of this invention is applied.

FIG. 5 is an exemplary flowchart for illustrating a modification monitoring method to which the information processing apparatus according to one embodiment of this invention is applied.

FIG. 6 is an exemplary diagram schematically showing a graphic display displayed by the information processing apparatus according to one embodiment of this invention.

FIG. 7 is an exemplary diagram schematically showing one example of modification information (detailed information) displayed on a graph displayed by the information processing apparatus according to one embodiment of this invention.

FIG. 8 is an exemplary diagram schematically showing another example of modification information (detailed information) displayed on a graph displayed by the information processing apparatus according to one embodiment of this invention.

FIG. 9 is an exemplary diagram schematically showing one example of a table used in the information processing apparatus according to one embodiment of this invention.

FIG. 10 is an exemplary diagram schematically showing display of alert information used in a modification monitoring method to which the information processing apparatus according to one embodiment of this invention is applied.

### DETAILED DESCRIPTION

Various embodiments according to the invention will be described hereinafter with reference to the accompanying drawings. In general, according to one embodiment of the invention, an information processing apparatus includes a storage device wherein an operating system is installed, a detecting module configured to detect a process of installing a program to be operated on the operating system into the storage device and a performance of the information processing apparatus, and a display unit configured to store information indicating the performance of the information processing apparatus and information indicating install program which are detected by the detecting module into the storage device and to display the stored each of the information indicating the performance of the information processing apparatus and the information indicating install program in associate with temporal sequence in a graphic form.

One embodiment of this invention will be described with reference to the accompanying drawings.

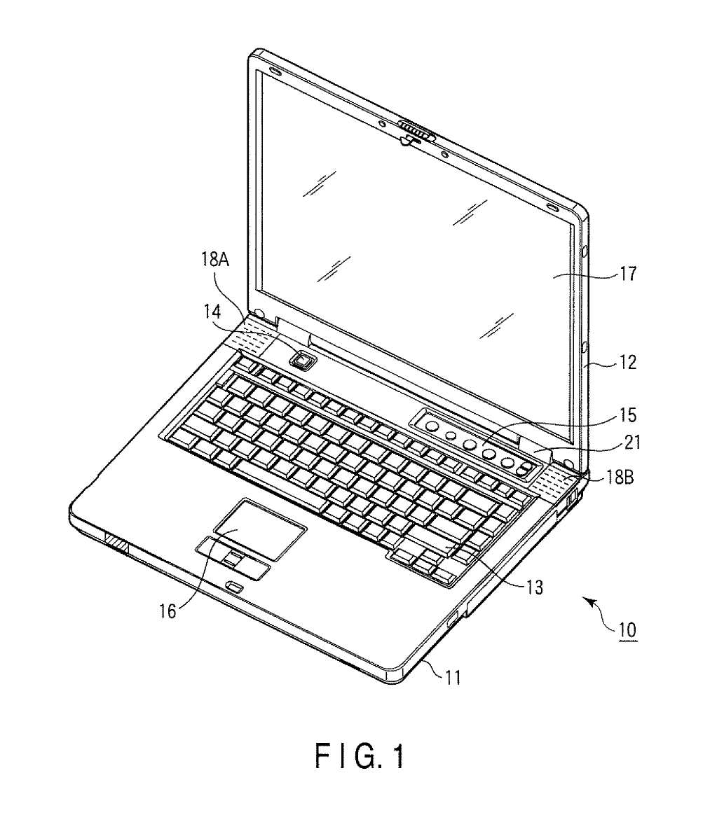

First, the configuration of an information processing apparatus according to one embodiment of this invention is explained with reference to FIG. 1. For example, the information processing apparatus of this embodiment is realized as a notebook portable personal computer 10.

The personal computer 10 has a resident modification monitoring application program (that is hereinafter also referred to as a monitoring application) that is operated on an operating system (OS). The application program monitors and detects installation of various device drivers and installation of various application programs operated on the operation system. Further, it time-sequentially monitors and detects update processes of various device drivers and update processes of various application programs.

Also, modification monitoring application program 202 detects and stores the performance of the computer 10. As the performance of the computer 10 includes boot time of the computer 10, the fragmentation rate of a hard disk (HDD), the frequency of use of the main memory, boot time of a program operated on the operating system and the like.

The modification monitoring application program can be used to permit information indicating the installed program and information indicating the performance of the computer 10 which are detected to be stored and which are displayed in associate with temporal sequence in a graphic form.

That is, a modification can be time-sequentially fined by comparing modifications in the performance of the computer 10 with the installed program.

If the user watches the graphic display, he can easily detect an associated modification in the program when the performance of the computer 10 is lowered.

FIG. 1 is a perspective view showing a state in which the display unit of the computer 10 is opened. The computer 10 includes a computer main body (housing) 11 and display unit 12. In the display unit 12, a display device configured by a thin-film-transistor liquid crystal display (TFT-LCD) 17 is incorporated.

The display unit 12 is mounted on the computer main body 11 by use of hinges 21 so as to be freely rotated (set in an open/closed state) between an open position in which the upper surface of the computer 10 is exposed and a closed position in which the upper surface of the computer 10 is covered with the display unit. The computer main body 11 has a thin box-shaped housing and a keyboard 13, a power button 14 that turns on/off the power source of the computer 10, an input operation panel 15, touchpad 16 and speakers 18A, 18B are arranged on the upper surface of the housing.

The input operation panel 15 is an input device that inputs an event corresponding to a button depressed and has a plurality of buttons to respectively boot a plurality of functions.

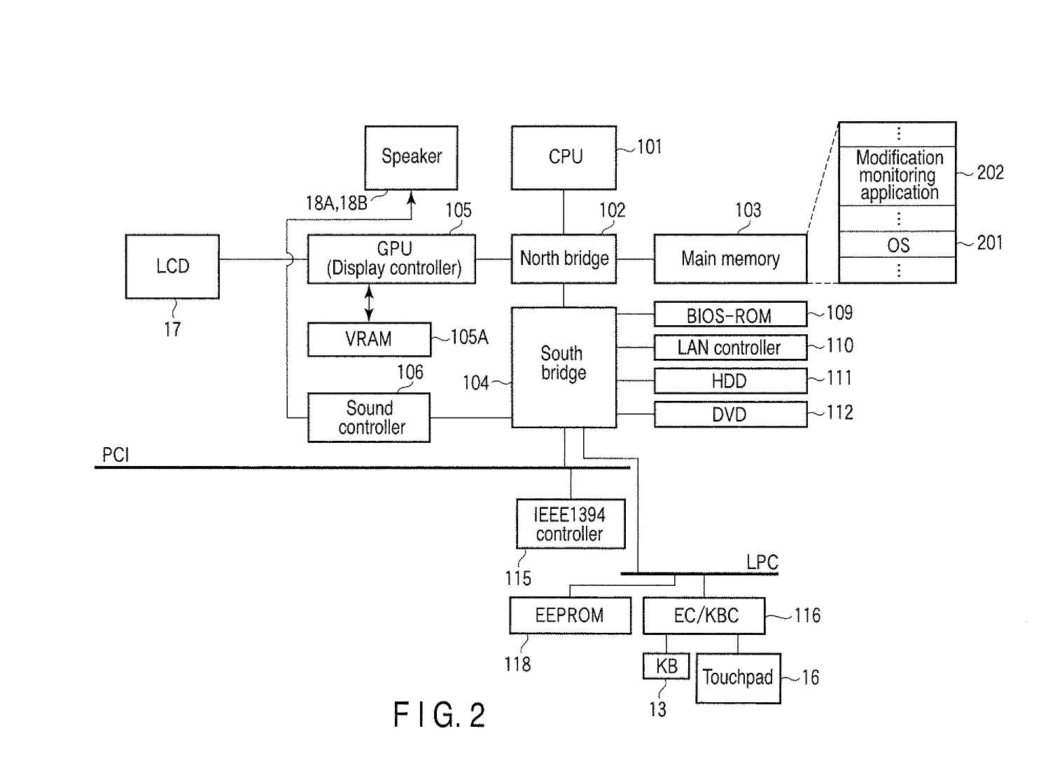

Next, the system configuration of the computer 10 is explained with reference to FIG. 2.

As shown in FIG. 2, the computer 10 includes a CPU (detecting module) 101, north bridge 102, main memory (memory) 103, south bridge 104, graphics processing module (GPU) 105, video memory (VRAM) 105A, sound controller 106, BIOS-ROM 109, LAN controller 110, hard disk drive (HOD: storage device) 111, DVD drive 112, IEEE 1394 controller 115, embedded controller/keyboard controller IC (EC/KBC) 116, LCD (display unit) 117, EEPROM 118 and the like.

The CPU 101 is a processor that controls the operation of the computer 10 and executes an operating system (OS) 201 loaded from the hard disk drive (HOD) 111 to the main memory 103 and various application programs such as a modification monitoring application program (detecting module, storage module) 202. The modification monitoring application program 202 is software that can be used to store information indicating the installed program detected and information indicating the performance of the computer 10 and display the thus stored information in a graphic form while the information are time-sequentially set in correspondence to each other.

The north bridge 102 is a bridge device that connects the south bridge 104 to the local bus of the CPU 101. The north bridge 102 contains a memory controller that controls access to the main memory 103. Further, the north bridge 102 has a function of communicating with the GPU 105 via a serial bus of PCI EXPRESS standard or the like.

The GPU 105 is a display controller that controls the LCD 17 used as a display monitor of the computer 10. A display signal generated from the GPU 105 is transmitted to the LCD 17 of the display unit 12 by use of short-range wireless communication.

The south bridge 104 controls various devices on a Low Pin Count (LPC) bus and various devices on a Peripheral Component Interconnect (PCI) bus. Further, the south bridge 104 contains an Integrated Drive Electronics (IDE) controller to control the hard disk drive (HDD) 111 and DVD drive 112. Also, the south bridge 104 has a function of communicating with the sound controller 106.

The sound controller 106 is a sound source device and outputs to-be-played audio data to the speakers 18A, 18B.

The wireless LAN controller 114 is a wireless communication device that makes wireless communication of IEEE 802.11 standard, for example. The IEEE 1394 controller 115 communicates with the external device via a serial bus of IEEE 1394 standard.

The embedded controller/keyboard controller IC (EC/KBC) 116 is a one-chip microcomputer in which an embedded controller for power management and a keyboard controller for controlling the keyboard (KB) 13 and touchpad 16 are integrated. The embedded controller/keyboard controller IC (EC/KBC) 116 has a function of turning on/off the power source of the computer 10 in response to an operation of the power button 14 by the user.

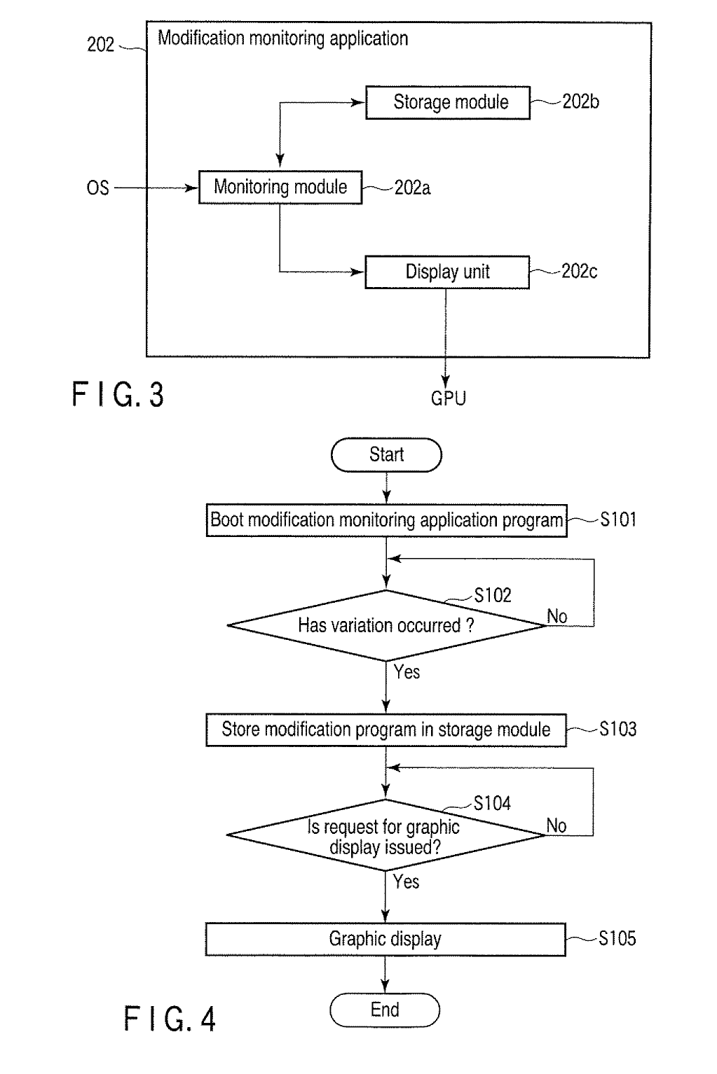

FIG. 3 is a block diagram showing the functional configuration of a monitoring application program.

The monitoring application program 202 has a detecting module 202a, storage module 202b and display unit 202c. The detecting module 202a performs a process of installing a program operated on the operating system and a process of monitoring the performance of the computer 10. As the performance of the computer 10, boot time of the computer 10, the fragmentation rate of a hard disk (HDD), the frequency of use of the main memory, boot time of a program operated on the operating system and the like are given. The storage module 202b time-sequentially stores information indicating the installed program detected by the detecting module and information indicating the performance of the computer 10. The display unit 202c time-sequentially sets the information stored in the storage module in correspondence to each other and outputs a signal used to graphically display the information on the LCD 17 to the GPU 105.

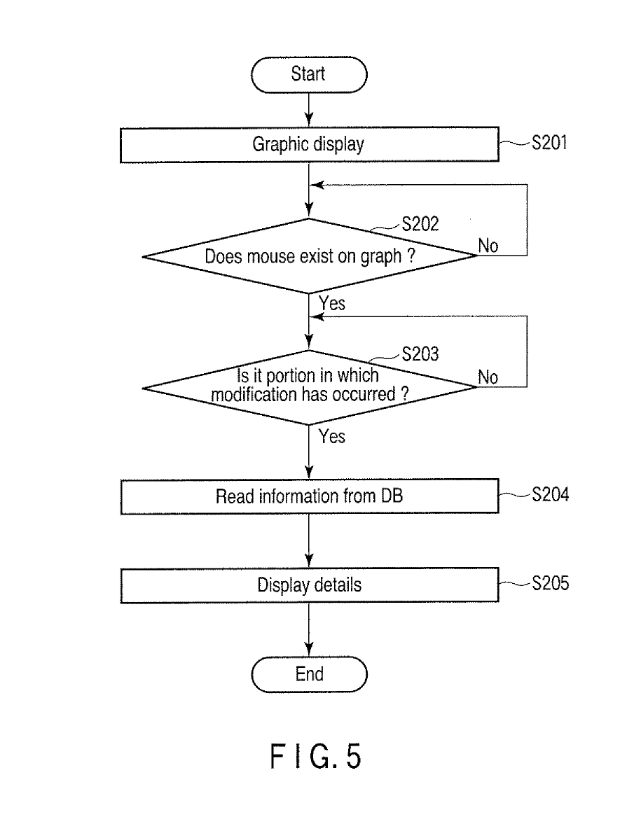

FIG. 4 and FIG. 5 are flowcharts for illustrating a program operation and a modification monitoring method to which the information processing apparatus according to one embodiment of this invention is applied.

The CPU 101 boots a modification monitoring application program 202 stored in the HDD 111 or the like and loads the same into the main memory 103 (block 5101). In this case, the modification monitoring application program 202 periodically monitors the performance of the computer 10 and stores the same into the HDD 111 or the like. It time-sequentially stores boot times of the computer 10. As the performance of the computer 10, the fragmentation rate of a hard disk (HOD), the frequency of use of the main memory, boot time of a program operated on the operating system and the like are given.

The CPU 101 monitors a process of installing a program operated on the operating system (block S102). As the process of installing the program, an install process of various application programs and various device drivers, an update process of various application programs and various device drivers and the like are given. Further, a BIOS update process, registry modification and the like can also be monitored. The update process of various application programs and various device drivers can be determined based on, for example, version information or the like stored in the registry by monitoring the registry.

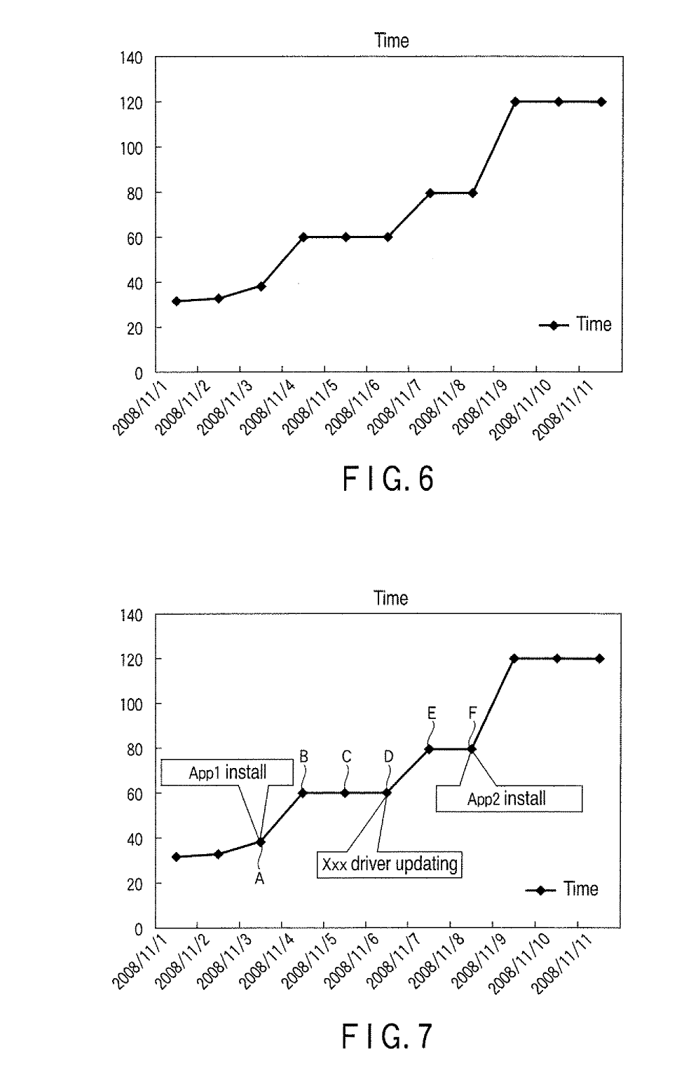

If it is determined in block 5102 by the CPU 101 that a modification has occurred (YES in block 5102), the modification (added) program are time-sequentially stored in the storage module 202b (block S103). When detecting a graphic display request from the user (YES in block 5104), for example, as shown in FIG. 6, the CPU 101 makes a graphic display of the performance of the computer 10 (boot time of the computer 10 in the case of FIG. 6) (block S105).

FIG. 5 is a flowchart for illustrating the operation performed when the user sets the mouse on a graph in a graphic display state.

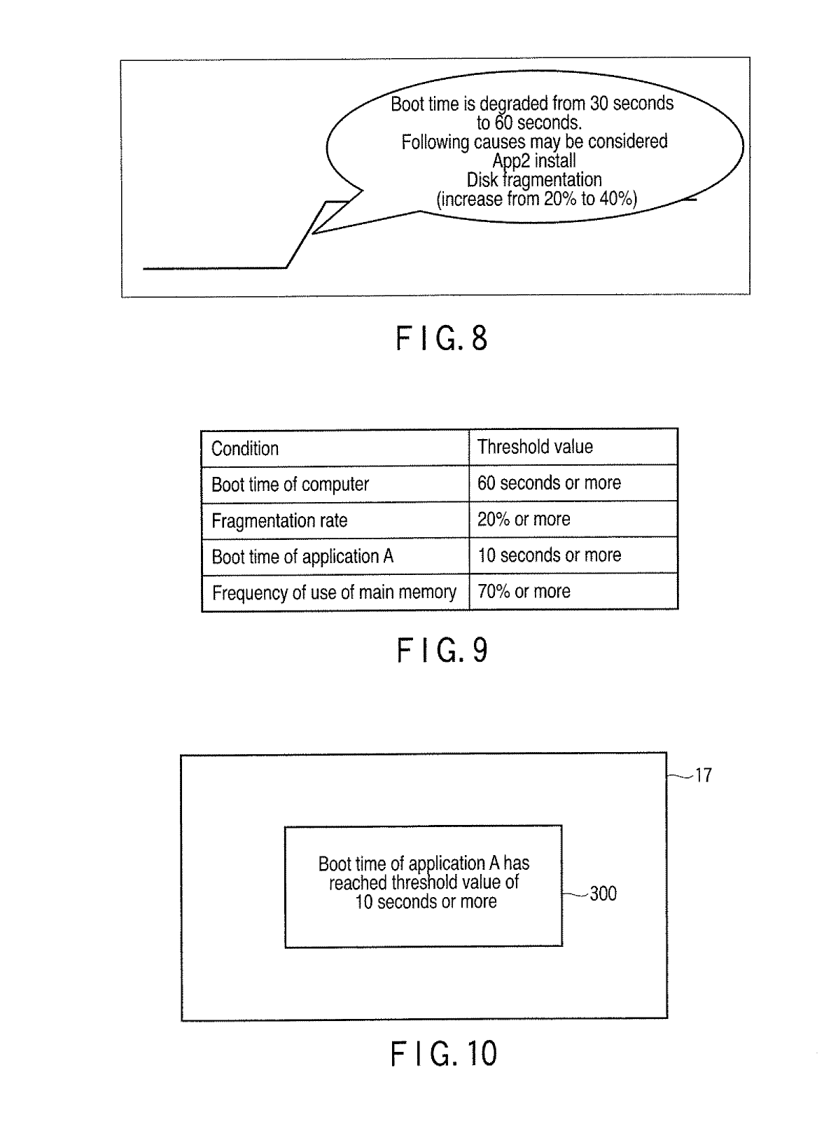

As shown in FIG. 6, for example, a graphic display requested by the user is made by the CPU 101 (block S201). The CPU 101 determines whether or not the mouse exists (or is set) on the graph (block S202). If it is determined in block 5202 that the mouse exists (or is set) on the graph (YES in block S202), the CPU 101 determines whether or not a modification has occurred in a portion of the graph on which the mouse is set (block 5203). For example, as shown in FIG. 7, if the portion is a portion A on the graph, it is determined that the performance of the computer 10 is changed (varied). Likewise, it is determined that no modification occurs in portions B, C, a modification occurs in a portion D, no modification occurs in a portion E, and a modification occurs in a portion F. If the CPU 101 determines in block S203 that a modification has occurred in the portion of the graph on which the mouse is set (YES in block S203), modification information (for example, program and driver installing process, update process, BIOS update process or registry update process) time-sequentially stored in the storage module 202b are read (block S204). For example, as shown in FIG. 7, the CPU 101 displays the read modification information (details) on a graph (block S205). Further, as another example of displaying modification information (details) on a graph, as shown in FIG. 8, a plurality of modification (added) program may be displayed and then further detailed information (such as information considered to be a cause of degradation of the performance of the computer 10) may be displayed. For example, “Boot time is degraded from 30 seconds to 60 seconds. The following causes are considered. App2 install; Disk fragmentation rate (increased from 20% to 40%)” may be displayed.

In the above embodiment, the performance of the computer 10 is periodically measured and stored, but this invention is not limited to this case. For example, the performance can be measured only when a modification is detected by use of the modification monitoring application program 202. By measuring the performance only when a modification is detected, a load on the computer 10 can be alleviated. Further, in this case, detailed modification information can be acquired when plural modifications occur in the periodic measurement periods in comparison with a case wherein the performance of the computer 10 is periodically measured.

According to the above embodiment, a modification can be time-sequentially grasped by comparing modifications in the performance of the computer 10 with the installed program. Further, since the graphic display is made and detailed information (modification information) is displayed on the graph in which the performance of the computer 10 is varied, the user can easily and intuitively predict the cause of degradation in the performance of the computer. That is, when the user senses degradation in the performance, he can easily predict a modification that gives an influence to the performance and easily take a measure to improve the performance. Since the system (the CPU 101 of the computer 10) informs the user of predicable causes when markedly large degradation in the performance is observed as the result of measurement of the performance, the user can easily provide maintenance without overlooking that degradation in the performance has occurred.

Next, a modification of the embodiment of this invention is explained.

Threshold values of information indicating the performance of the computer 10 are previously stored in the storage module 202b. For example, the following data are stored as table data as shown in FIG. 9.

Boot time of computer: 60 seconds or more

Fragmentation rate: 20% or more

Boot time of application A: 10 seconds or more

Frequency of use of main memory: 70% or more

When the above threshold values are reached, alert information is issued to the user. For example, as shown in FIG. 10, when the boot time of the application A has reached the threshold value of 10 seconds or more, alert information 300 is displayed on the LCD 17 of the computer 10 to inform the user to this effect, for example. Further, it may be connected to Internet or the like via the LAN controller 110 and it becomes possible to inform the user by use of a mail or the like.

An object of this invention is to provide an information processing apparatus, modification monitoring method and program capable of time-sequentially acquiring a modification by comparing a modification in the performance of the information processing apparatus with an installed program.

According to the modification of this invention, it is possible to automatically inform the user when a request of a graphic display is not issued from the user or when a desired modification occurs without setting the mouse on a portion on which a modification in the graphic display has occurred.

Further, the information processing apparatus of this embodiment can be realized not only by the computer 10 but also by various consumer information processing apparatuses such as PDA. In addition, the function of the modification monitoring application 202 can be realized by using hardware such as a DSP, microcomputer or the like. A module can be accomplished in software and hardware.

In addition, the application program is stored storage medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage device wherein an operating system is installed,
a detecting module configured to detect a process of installing a program to be operated on the operating system into the storage device and a performance of the information processing apparatus, and
a display unit configured to store information indicating the performance of the information processing apparatus and information indicating install program which are detected by the detecting module into the storage device and to display the stored each of the information indicating the performance of the information processing apparatus and the information indicating install program in associate with temporal sequence in a graphic form.

2. The information processing apparatus of claim 1, wherein the program comprises any one of a device driver and an application program operated on the operating system.

3. The information processing apparatus of claim 2, wherein the process of installing the program comprises any one of an install process of the application program and an update process of the application program.

4. The information processing apparatus of claim 2, wherein the process of installing the program comprises any one of an install process of the device driver and an update process of the device driver.

5. The information processing apparatus of claim 1, further comprising a memory that loads the operating system from the storage device and wherein the information indicating the performance of the information processing apparatus comprises at least one of boot time of the information processing apparatus, a fragmentation rate of the storage device, a frequency of use of the memory and boot time of a program to be operated on the operating system.

6. The information processing apparatus of claim 1, wherein the storage module previously stores a threshold value of the information indicating the performance of the information processing apparatus and issues alert information when the threshold value is reached.

7. A modification monitoring method in an information processing apparatus comprising a storage device wherein an operating system is installed, comprising:
detecting a process of installing a program to be operated on the operating system into the storage device and a performance of the information processing apparatus,
storing information indicating the performance of the information processing apparatus and information indicating install program which are detected by the detecting into the storage device, and
displaying the stored each of the information indicating the performance of the information processing apparatus and the information indicating install program in associate with temporal sequence in a graphic form.

8. The modification monitoring method of claim 7, wherein the program comprises any one of a device driver and an application program operated on the operating system.

9. The modification monitoring method of claim 8, wherein the process of installing the program comprises any one of an install process of the application program and an update process of the application program.

10. The modification monitoring method of claim 8, wherein the process of installing the program comprises any one of an install process of the device driver and an update process of the device driver.

11. The modification monitoring method of claim 7, wherein the information processing apparatus further comprising a memory configured to load the operating system from the storage device and the information indicating the performance of the information processing apparatus comprises at least one of boot time of the information processing apparatus, a fragmentation rate of the storage device, a frequency of use of the memory and boot time of a program operated on the operating system.

12. The modification monitoring method of claim 7, wherein the storage module previously stores a threshold value of the information indicating the performance of the information processing apparatus and issues alert information when the threshold value is reached.

13. A program in an information processing apparatus comprising a storage device wherein an operating system is installed, comprising:
a detecting procedure of detecting a process of installing a program to be operated on the operating system into the storage device and a performance of the information processing apparatus,
a storing procedure of storing information indicating the performance of the information processing apparatus and information indicating install program which are detected by the detecting procedure into the storage device, and
a displaying procedure of displaying the stored each of the information indicating the performance of the information processing apparatus and the information indicating install program in associate with temporal sequence in a graphic form.
